(19) United States
(12) Patent Application Publication
(10) Pub. No.: US 2024/0400084 A1
(43) Pub. Date: Dec. 5, 2024

(54) Glass Composition Having Low Iron and Low Redox

(71) Applicant: Vitro Flat Glass LLC, Cheswick, PA (US)

(72) Inventor: José Guadalupe Cid-Aguilar, Monterrey (MX)

(21) Appl. No.: 18/660,477

(22) Filed: May 10, 2024

Related U.S. Application Data
(60) Provisional application No. 63/505,733, filed on Jun. 2, 2023.

(51) Int. Cl. B60W 60/00; B32B 17/10; B60W 50/00; C03C 3/087

(52) U.S. Cl. CPC B60W 60/00; B32B 17/10036; B32B 17/10119; C03C 3/087; B32B 2250/03; B32B 2250/40; B32B 2307/412; B32B 2307/42; B32B 2605/08; B60W 2050/0082; B60W 2554/80; B60W 2720/00

(57) ABSTRACT

A glass composition including: from 65 to 75 weight % SiO₂; from 10 to 20 weight % Na₂O; from 5 to 15 weight % CaO; from 0 to 5 weight % MgO; from 0 to 5 weight % Al₂O₃; from 0 to 5 weight % K₂O; from greater than 0 and up to 0.03 weight % total iron (Fe₂O₃); and from greater than 0 and up to 0.003 weight % FeO.

### CROSS-REFERENCE TO RELATED APPLICATIONS

This application claims priority to U.S. Provisional Application No. 63/505,733 filed Jun. 2, 2023, the disclosure of which is hereby incorporated by reference in its entirety.

### BACKGROUND

### Field

The present disclosure is directed to a glass composition, a glass substrate formed from the glass composition, a vehicle comprising the glass substrate, and a method of operating an autonomous vehicle in a system comprising the glass composition.

### Technical Considerations

Transparencies are included in vehicles to allow a user inside to see out and to allow light to enter the inside of the vehicle. As such, the visible light transmission of the transparencies is often a design consideration when developing transparencies used in vehicles. However, with the increasing prevalence of vehicles using sensors to sense their surroundings, such as in autonomous vehicles, transmission of certain wavelengths outside of the visible spectrum is becoming increasingly important. For example, certain radiation sources and sensors may emit and/or detect radiation in certain bands of the infrared region, and these sensors may be positioned behind transparencies, such that the emitted and/or detected radiation may be incident to the transparencies. Thus, high transmission of these select wavelengths may also be a design consideration when developing transparencies used in vehicles.

### SUMMARY OF THE DISCLOSURE

According to some non-limiting aspects of the disclosure, a glass composition includes: from 65 to 75 weight % SiO₂; from 10 to 20 weight % Na₂O; from 5 to 15 weight % CaO; from 0 to 5 weight % MgO; from 0 to 5 weight % Al₂O₃; from 0 to 5 weight % K₂O; from greater than 0 and up to 0.030 weight % total iron (Fe₂O₃); and from greater than 0 and up to 0.003 weight % FeO.

In some non-limiting aspects, the glass composition may include from 0.002 to 0.025 weight % total iron. The glass composition may include a sum of colorants less than 1 weight %, where the sum of colorants include iron-containing, manganese-containing, and chromium-containing compounds. The glass composition may include a redox ratio (FeO/Fe₂O₃) of up to 0.35. The glass composition may include from 0.0001 to 0.0075 weight % Cr₂O₃ and/or from 0.0005 to 0.2 weight % MnO₂. The glass composition may include from 0.0001 to 0.0075 weight % Cr₂O₃ and from 0.0005 to 0.2 weight % MnO₂. The glass composition may form a colorless glass. The glass composition may form a glass having an L* value of at least 85; an a* value from −2.5 to +5.0; and a b* value from −1.0 to +5.0. A glass substrate formed from the glass composition may have a transmission at 905 nm and/or at 1550 nm of at least 91%. A glass substrate formed from the glass composition may have a T_{Vis} of at least 85% using CIE standard illuminant A. A glass substrate formed from the glass composition may have a T_{IR} of at least 85%, as determined by ISO 13837. A glass substrate formed from the glass composition may have a T_{Vis}/T_{IR} of at least 0.9, T_{Vis} determined using CIE standard illuminant A and T_{IR} determined by ISO 13837. The glass composition may be substantially free of a vanadium-containing compound. The glass composition may include from 0.15 to 0.40 weight % SO₃.

According to some non-limiting aspects of the disclosure, a glass substrate is formed from a glass composition described herein. At least a portion of the glass substrate may be free of a coating layer.

According to some non-limiting aspects of the disclosure, a vehicle may include a glass substrate formed from a glass composition described herein.

In some non-limiting aspects, the glass substrate may include: a first glass panel including a No. 1 surface and an opposing No. 2 surface; a second glass panel including a No. 4 surface and an opposing No. 3 surface; and an interlayer positioned between the first glass panel and the second glass panel, where the interlayer contacts the No. 2 surface and the No. 3 surface. The interlayer may include polyvinyl butyral (PVB). The glass substrate may at least partially enclose an infrared radiation source positioned to emit near-infrared radiation in a range of 800 nm to 2500 nm through the glass substrate. The vehicle may further include an infrared radiation detector positioned to detect reflected near-infrared radiation in a range of 800 nm to 2500 nm, where the reflected near-infrared radiation includes at least a portion of the near-infrared radiation emitted by the infrared radiation source. The glass substrate may have a transmission at 905 nm and/or at 1550 nm of at least 91%. The glass substrate may include a windshield.

According to some non-limiting aspects of the disclosure, a method of operating an autonomous vehicle includes: emitting near-infrared radiation in a range of 800 nm to 2500 nm from an infrared radiation source mounted on the vehicle, where the emitted near-infrared radiation is transmitted through a glass substrate on the vehicle formed from the glass composition according to claim 1; and detecting near-infrared radiation in a range of 800 nm to 2500 nm reflecting off an object with an infrared radiation detector mounted on the vehicle, where the reflected near-infrared radiation includes at least a portion of the near-infrared radiation emitted by the infrared radiation source.

In some non-limiting aspects, the glass substrate may have a transmission at 905 nm and/or at 1550 nm of at least 91%. The method may further include determining, with at least one processor, at least one condition of the vehicle's surroundings based on the detected near-infrared radiation. The method may further include modifying, with at least one processor, at least one operation of the vehicle based on the determined at least one condition.

### BRIEF DESCRIPTION OF THE DRAWINGS

The disclosure will be described with reference to the following drawing figures wherein like reference numbers identify like parts throughout.

FIG. 1 shows a side view (not to scale) of a glass substrate (multi-ply) formed from a glass composition, according to some aspects of the disclosure.

FIG. 2 shows a side view (not to scale) of a glass substrate (monolithic) formed from a glass composition, according to some aspects of the disclosure.

FIG. 3 shows a top view (not to scale) of a glass substrate formed from a glass composition and having a coated region and an uncoated region, according to some aspects of the disclosure.

FIGS. 4 and 5 show schematic views (not to scale) of detection systems, according to some aspects of the disclosure.

FIG. 6 shows a schematic view (not to scale) of a control system, according to some aspects of the disclosure.

### DETAILED DESCRIPTION

As used herein, spatial or directional terms, such as “left”, “right”, “inner”, “outer”, “above”, “below”, and the like, relate to the disclosure as it is shown in the drawing figures. However, it is to be understood that the disclosure can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims may vary depending upon the desired properties sought to be obtained by the present disclosure. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. “A” or “an” refers to one or more.

Any reference to composition amounts, unless otherwise specified, is “by weight percent” based on the total weight of the final glass composition. The “total iron” content of the glass compositions disclosed herein is expressed in terms of Fe₂O₃ in accordance with standard analytical practice, regardless of the form actually present. Likewise, the amount of iron in the ferrous state is reported as FeO, even though it may not actually be present in the glass as FeO. The terms “redox”, “redox ratio”, or “iron redox ratio” mean the amount of iron in the ferrous state (expressed as FeO) divided by the amount of total iron (expressed as Fe₂O₃ and including iron amounts in the ferrous states and ferric state).

Iron can be found in glass in two different oxidation states: Fe²⁺, as ferrous oxide (FeO) and Fe³⁺, as ferric oxide (Fe₂O₃). Each ion confers different properties. The ferrous ion has a broad and strong absorption band centered at 1050 nm, which translates into a decrease in infrared radiation. In addition, this band extends to the visible region decreasing the transmission of light and imparting a bluish coloration on the glass. The ferric ion has a strong absorption band located in the ultraviolet region, which avoids its transmission through the glass and, in addition, it has two weak bands in the visible region located between 420 and 440 nm, which causes a slight decrease in light transmission and a yellowish coloration in the glass.

The balance between ferrous and ferric oxide has a direct effect on the characteristics of the color and transmittance of the glass.

$$Iron Redox Ratio = \frac{{Fe}^{2 +} ( as wt . \% FeO )}{Total Fe ( as wt . \% {Fe}_{2} {O}_{3} )}$$

The term “iron redox ratio” means the amount of iron in the ferrous state (expressed as FeO) divided by the amount of total iron (expressed as Fe₂O₃).

Further, as used herein, the terms “formed over”, “deposited over”, “arranged over”, or “provided over” mean formed, deposited, arranged, or provided on but not necessarily in contact with the surface. For example, a coating layer “arranged over” a substrate does not preclude the presence of one or more other coating layers or films of the same or different composition located between the formed coating layer and the substrate.

Additionally, all documents, such as, but not limited to, issued patents and patent applications, referred to herein are to be considered to be “incorporated by reference” in their entirety.

The present disclosure is directed to a glass composition, comprising: from 65 to 75 weight % SiO₂; from 10 to 20 weight % Na₂O; from 5 to 15 weight % CaO; from 0 to 5 weight % MgO; from 0 to 5 weight % Al₂O₃; from 0 to 5 weight % K₂O; from greater than 0 and up to 0.030 weight % total iron (Fe₂O₃); and from greater than 0 and up to 0.003 weight % FeO.

Non-limiting examples of suitable glass materials formed from the glass composition include conventional soda-lime-silicate glass, borosilicate glass, or leaded glass. The glass can be clear glass. By “clear glass” is meant non-tinted or non-colored glass. The glass can be annealed or heat-treated glass. As used herein, the term “heat treated” means tempered or at least partially tempered. The glass can be of any type, such as conventional float glass, and can be of any composition having any optical properties, e.g., any value of visible transmission, ultraviolet transmission, infrared transmission, and/or total solar energy transmission. By “float glass” is meant glass formed by a conventional float process in which molten glass is deposited onto a molten metal bath and controllably cooled to form a float glass ribbon. Examples of float glass processes are disclosed in U.S. Pat. Nos. 4,466,562 and 4,671,155.

Table 1 lists the major components and their respective ranges in weight percent for non-limiting embodiments of glass compositions prepared according to the present disclosure.

TABLE 1

| Major Component | Range |
|---|---|
| SiO₂ | 65-75% |
| Na₂O | 10-20% |
| CaO | 5-15% |
| MgO | 0-5% |
| Al₂O₃ | 0-5% |
| K₂O | 0-5% |

While iron may not be intentionally added to the glass composition, it may also be present in the glass composition as ferrous iron, ferric iron, or a combination of ferrous and ferric iron.

The glass composition may comprise ferrous iron (FeO) in an amount of from greater than 0 and up to 0.003 weight %, such as from greater than 0 and up to 0.0025 weight %, from greater than 0 and up to 0.002 weight %, from greater than 0 and up to 0.0015 weight %, or from greater than 0 and up to 0.001 weight %.

The glass composition may comprise an amount of total iron (Fe₂O₃) in an amount of from greater than 0 and up to 0.030 weight %, such as from 0.02 to 0.025 weight %, from 0.002 to 0.02 weight %, from 0.002 to 0.015 weight %, from 0.002 to 0.01 weight %, or from 0.006 to 0.025 weight %.

The glass composition may comprise a redox ratio (FeO/Fe₂O₃) of up to 0.35, such as up to 0.30, up to 0.25, up to 0.20, or up to 0.10.

The glass composition may comprise SO₃ in an amount of up to 0.40 weight %, such as up to 0.38 weight %, up to 0.35 weight %, or up to 0.30 weight %. The glass composition may comprise SO₃ in an amount of from 0.15 to 0.40 weight %, such as from 0.15 to 0.38 weight %, from 0.15 to 0.35 weight %, from 0.15 to 0.30 weight %, or from 0.20 to 0.38 weight %.

Table 2 lists iron-containing components and their respective ranges in weight percent, as well as the redox ratio, for non-limiting embodiments of glass compositions prepared according to the present disclosure. Table 2 also lists SO₃ and its weight percent for non-limiting embodiments of glass compositions prepared according to the present disclosure.

TABLE 2

| Component | Range | Preferred Range | More Preferred Range |
|---|---|---|---|
| FeO | >0-0.003 | >0-0.0025 | >0-0.002 |
| Total Iron | >0-0.030 | 0.002-0.025 | 0.006-0.025 |
| Redox Ratio | ≤0.35 | ≤0.30 | ≤0.25 |
| SO₃ | ≤0.40 | ≤0.38 | 0.15-0.38 |

The glass composition may further comprise oxidizing components that may oxidize the ferrous and/or ferric iron in the glass composition. Non-limiting examples of oxidizing components include chromium (III) oxide (Cr₂O₃) and manganese dioxide (MnO₂). The glass composition may comprise Cr₂O₃, MnO₂, or both Cr₂O₃ and MnO₂.

If Cr₂O₃ is present, the glass composition may comprise from 0.0001 to 0.0075 weight % Cr₂O₃, such as from 0.0001 to 0.007 weight %, from 0.0001 to 0.005 weight %, or from 0.0003 to 0.007 weight %.

If MnO₂ is present, the glass composition may comprise from 0.0005 to 0.20 weight % MnO₂, such as from 0.0005 to 0.10 weight %, from 0.0005 to 0.08 weight %, or from 0.0009 to 0.15 weight %. In some non-limiting embodiments, the MnO₂ is present in the glass composition in an amount up to 0.2 weight %, such as up to 0.1 weight %, up to 0.08 weight %, or up to 0.05 weight %.

If Cr₂O₃ and MnO₂ are both present in the glass composition, they may be included in amounts described in the foregoing ranges.

It is noted that weight % of metal oxide components is based on the total weight of the metal oxide compound (and not just on the weight of the metal of the metal oxide compound).

Table 3 lists oxidizing components and their respective ranges in weight percent for non-limiting embodiments of glass compositions prepared according to the present disclosure.

TABLE 3

| Component | Range | Preferred Range |
|---|---|---|
| Cr₂O₃ | 0.0001 to 0.0075 | 0.0003 to 0.007 |
| MnO₂ | 0.0005 to 0.2 | 0.0009 to 0.15 |

Fe₂O₃ (including FeO), Cr₂O₃, and MnO₂ disclosed herein may also be considered colorants. The sum of these colorants in the glass composition may be less than 1.0 weight %, such as up to 0.15 weight %, or up to 0.10 weight %. The sum of these colorants in the glass composition may range from 0.005 to 1.0 weight %, such as 0.005 to 0.2 weight %, 0.008 to 1.0 weight %, 0.008 to 0.2 weight %, 0.008 to 0.18 weight %, 0.008 to 0.15 weight %, or 0.008 to 0.10 weight %.

Table 4 lists the sum of the following colorants: Fe₂O₃ (including FeO), Cr₂O₃, and MnO₂ and their range in weight percent for non-limiting embodiments of glass compositions prepared according to the present disclosure.

TABLE 4

| Component | Range | Preferred Range | More Preferred Range |
|---|---|---|---|
| Σ Fe₂O₃, Cr₂O₃, | <1.0 | 0.005-0.2 | 0.008-0.18 |
| and MnO₂ | | | |
| Colorants | | | |

The glass composition may be substantially free of a vanadium-containing compound. The glass composition may be substantially free of a cobalt-containing compound. The glass composition may be substantially free of a copper-containing compound. The glass composition may be substantially free of a selenium-containing compound. The glass composition may be substantially free of a rare earth element-containing compound (e.g., CeO₂, Er₂O₃, and the like). The glass composition being substantially free of a compound may mean that the compound is not intentionally added to the glass composition and may only be present in incidental amounts up to 0.005 ppm. The glass composition may be completely free of each of these compounds, thus containing 0 weight % of each of these compounds.

The glass composition may optionally comprise titania (TiO₂). The amount of titania contained in the glass composition may depend on the sand used to form the glass composition, since titania can be an impurity in the sand introduced into the glass composition. Additionally or alternatively, the amount of titania may be intentionally added to be within a predetermined range. If present, the amount of titania in the glass composition may be up to 0.06 weight %, such as up to 0.025 weight %, up to 0.02 weight %, up to 0.015 weight %, up to 0.01 weight %. If present, the amount of titania in the glass composition may range from 0.005 to 0.06 weight %, such as from 0.005 to 0.025 weight %, from 0.005 to 0.02 weight %, or from 0.005 to 0.01 weight.

The glass composition described herein may be formed into a glass substrate. The glass composition of the present disclosure may be melted and refined in a continuous, large-scale, commercial glass melting operation and formed into flat glass sheets of varying thickness by the float method in which the molten glass is supported on a pool of molten metal, usually tin, as it assumes a ribbon shape and is cooled in a manner well known in the art to form the glass substrate. It will be appreciated that alternative methods of forming glass substrates from glass compositions are also within the scope of this disclosure.

With the glass substrate formed from the glass composition described herein comprising colorants in the low amounts described herein, the glass composition may form a colorless glass. The colorless glass may have the following CIE color properties:
An L* value of at least 85, such as at least 90, or at least 95;
An a* value of from −2.5 to +5.0, such as from −1.0 to +3.0; and
A b* value of from −1.0 to +5.0, such as from 0 to +5.0.

Color (e.g., L*, a*, b*) and spectral (e.g., transmission) properties are based on a reference thickness of the glass of 3.85 mm. Further, color and spectral properties reported herein are of an uncoated glass substrate.

Glass color in terms of L*, a* and b*, are calculated from the tristimulus values (X, Y, Z) and identify the characteristics of lightness and hue, respectively, in the system commonly referred to as the CIELAB color system. The lightness, or L* value, distinguishes the degree of lightness or darkness and indicates the lightness or darkness of the color and represents the lightness plane on which the color resides. Hue distinguishes colors such as red, yellow, green and blue. The symbol “a*” indicates the position of the color on a red (+a*) green (−a*) axis. The symbol “b*” indicates the color position on a yellow (+b*) blue (−b*) axis. It should be appreciated that color can be characterized in any suitable color systems. The L*, a*, and b* values are determined using the reference illuminant (D65) and a Lambda 1050 spectrophotometer, commercially available from Perkin-Elmer Corporation. A detailed discussion of color calculations is given in U.S. Pat. No. 5,792,559. The disclosure of U.S. Pat. No. 5,792,559 in its entirety is incorporated herein by reference.

The glass substrate formed from the glass composition may have the following spectral properties.

The glass substrate may have a transmission at 905 nm and/or at 1550 nm of at least 90%, such as at least 90.3%, at least 90.5%, or at least 91%, as measured using a Lambda 1050 spectrophotometer.

The glass substrate may have a visible transmission Tᵥᵢₛ of at least 75%, such as at least 80%, at least 85%, or at least 90%, determined using the conventional CIE Illuminant A and a 2-degree observer angle.

The glass substrate may have an infrared transmission T_{IR} of at least 85%, such as at least 90% or at least 91%, as determined by ISO 13837.

The glass substrate may have a Tᵥᵢₛ/T_{IR} of at least 0.8, such as at least 0.9 or at least 1.0, with Tᵥᵢₛ and T_{IR} determined as previously described.

Glass substrates having these color and spectral properties may be sufficiently transparent in the visible region for a user (e.g., a vehicle driver) to see through the glass, while also being sufficiently transparent in the infrared region (or subregions thereof) so as to not obstruct radiation detectors and sources emitting or detecting radiation in the infrared region.

At least a portion of the glass substrate may be free of a coating. In some non-limiting embodiments, the glass substrate may be coated with a coating, and at least a portion of the applied coating may be removed such that a first portion of the glass is coated, while a second portion of the glass is uncoated. The uncoated region may be a region of the glass substrate configured to be incident with infrared radiation emitted or detected by a radiation source or detector, as described herein.

The coating may comprise any glass coating known in the art, such as solar control coatings that block (e.g., by reflection and/or fluorescence) at least a portion of the solar radiation incident to the coating, so as to regulate the temperature of the environment enclosed by the glass substrate, such as the interior of a vehicle. As used herein, the term “solar control coating” refers to a coating comprised of one or more layers or films that affect the solar properties of the coated glass substrate, such as, but not limited to, the amount of solar radiation, for example, visible, infrared, or ultraviolet radiation, reflected from, absorbed by, or passing through the coated article; shading coefficient; emissivity, etc. The solar control coating can block, absorb, or filter selected portions of the solar spectrum, such as, but not limited to, the IR, UV, and/or visible spectrums, or portions thereof. Non-limiting examples of solar control coatings are described, for example, in U.S. Pat. Nos. 10,345,499; 10,358,384; 10,539,726; 10,703,673; 11,078,718; 11,267,752; 11,402,557.

The coating may be deposited directly over the glass substrate or another coating layer by any suitable method, such as, but not limited to, chemical vapor deposition (CVD) and/or physical vapor deposition (PVD) methods. Examples of CVD processes include spray pyrolysis. Examples of PVD processes include electron beam evaporation and vacuum sputtering (such as magnetron sputter vapor deposition (MSVD)). Other coating methods could also be used, such as, but not limited to, sol-gel deposition. In one non-limiting embodiment, a coating layer is deposited by MSVD. Examples of MSVD coating devices and methods will be well understood by one of ordinary skill in the art and are described, for example, in U.S. Pat. Nos. 4,379,040; 4,861,669; 4,898,789; 4,898,790; 4,900,633; 4,920,006; 4,938,857; 5,328,768; and 5,492,750.

Alternatively, the entire glass substrate may be free of a coating.

The glass substrate may be of any desired dimensions, e.g., length, width, shape, or thickness. In some non-limiting embodiments in which the substrate is a vehicle (e.g., automotive) transparency, the glass substrate may be 1-10 mm thick, such as 1-8 mm thick, such as 2-8 mm, such as 3-7 mm, such as 5-7 mm, such as 4-6 mm thick.

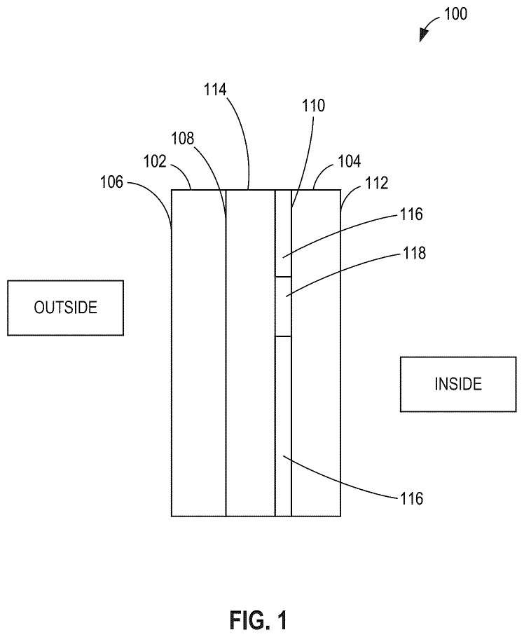

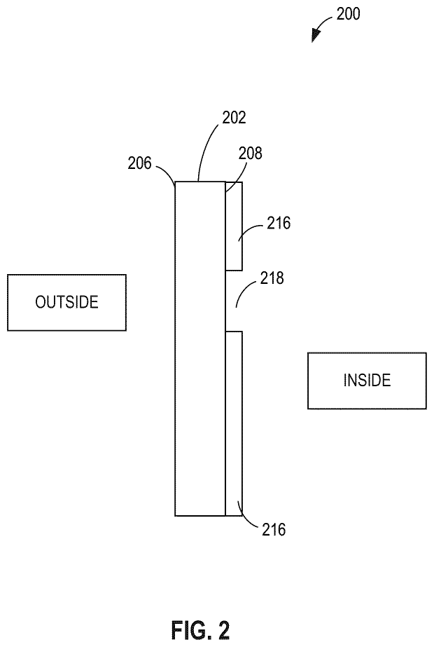

Referring to FIGS. 1 and 2, the glass substrate of the present disclosure may be a component of a transparency 100, 200. The transparency 100, 200 may be a transparency in a vehicle. The type of vehicle is not particularly limited and may include, for example, at least one of a land, air, space, above water, and underwater vehicle. The vehicle may be an automobile or an airplane. The transparency 100, 200 may be a vehicle window, such as a front or rear windshield, a driver or passenger door window, a sunroof or moonroof, or the like of a vehicle. However, it is to be understood that the transparency 100, 200 described herein is not limited to use with such vehicular transparencies but could be practiced with transparencies in any desired field, such as, but not limited to, laminated or non-laminated residential and/or commercial windows, insulating glass units, and the like.

Referring to FIG. 1, the transparency 100 may comprise two plies (each comprising a glass), such as first and second plies 102, 104 as shown. However, further plies may be included in the transparency, such as a three or four ply transparency. Alternatively, the transparency may have a single ply (see FIG. 2).

In broad practice, the plies 102, 104 can be of the same or different materials. The plies 102, 104 can each comprise, for example, clear float glass. Although not limiting, examples of glass suitable for the first ply 102 and/or second ply 104 are described in U.S. Pat. Nos. 4,746,347; 4,792,536; 5,030,593; 5,030,594; 5,240,886; 5,385,872; and 5,393,593.

The transparency 100 of FIG. 1 may be a transparency 100 in a vehicle, such as a windshield. The transparency 100 may comprise the first ply 102 with a first major surface 106 (No. 1 surface) and an opposed second major surface 108 (No. 2 surface). In the illustrated non-limiting embodiment, the first major surface 106 faces the vehicle exterior, i.e., is an outer major surface exposed to an outdoor side of the vehicle structure, and the second major surface 108 faces the interior of the vehicle. The second ply 104 has an inner (third) major surface 110 (No. 3 surface) and an outer (fourth) major surface 112 (No. 4 surface). The fourth major surface 112 is the surface exposed to an indoor side of the vehicle. This numbering of the ply surfaces is in keeping with conventional practice in the vehicular art.

The transparency 100 may be mounted in a vehicle body of the vehicle. Non-limiting examples of the vehicle body include: an automobile roof in the case of a sunroof, an automobile door or frame in the case of an automobile windshield or window, or a fuselage of an airplane. The transparency 100 may be affixed to a mechanism by which the transparency 100, such as a car window or sunroof, can be opened and closed, as is broadly known in the vehicular arts.

With continued reference to FIG. 1, an interlayer 114 may be positioned between the first ply 102 and the second ply 104, wherein the interlayer 114 may contact the second major surface 108 and the third major surface 110. The first ply 102, interlayer 114, and second ply 104 may be connected in any suitable manner, such as by being adhesively bonded to one another or fixed together in a frame. The interlayer 114 may be made of any suitable material. In some non-limiting embodiments, the interlayer 114 may comprise polyvinyl butyral (PVB). The interlayer 114 may comprise a polyurethane.

With continued reference to FIG. 1, the transparency 100 may have a coating 116 on at least a portion of a surface of a ply. For example, the coating 116 may be on the third major surface 110), although it will be appreciated that the coating 116 can additionally or alternatively be applied on other plies/surfaces. For example, the coating 116 may additionally or alternatively be applied to the second major surface 108, as the second major surface 108 is also a major surface of an interior portion of the transparency 100 (whereas the first major surface 106 and the fourth major surface 112 are exterior portions of the transparency 100 exposed to the outdoor environment and vehicle interior environment, respectively). For example, the coating 116 may additionally or alternatively be applied to the fourth major surface 112, and in such examples, a protective coating layer (not shown) may be applied over the coating 116 to protect the coating 116 from the environment.

The coated surface (e.g., the third major surface 110) may have an uncoated region 118 not coated by the coating 116. The uncoated region 118 may have never been contacted with the coating 116 (e.g., coating via a masking process) or the coating 116 applied to the uncoated region 118 may subsequently be removed to form the uncoated region 118. The uncoated region 118 may be a region of the transparency 100 though which radiation (e.g., infrared radiation) from a radiation source and/or detected by a radiation detector may transmit without being reflected and/or fluoresced to the same degree as the coating 116 designed to reflect and/or fluoresce the same radiation to a higher degree.

Referring to FIG. 2, the transparency 200 shown and described is similar to the transparency 100 from FIG. 1 except as described hereinafter. It will be appreciated that components from the drawing figures having the same final two digits of their reference number have the same or similar characteristics except to the extent explicitly described herein. For example, uncoated region 118 from FIG. 1 has the same or similar characteristics as uncoated region 218 from FIG. 2 except where explicitly described herein, due to the final two digits of the element numbers both being “18”.

The transparency 200 of FIG. 2 differs from the transparency of FIG. 1 100 in that the transparency 200 does not comprise an interlayer 114, a second ply 104, a third major surface 110, or a fourth major surface 112 as described in FIG. 1. The transparency 200 comprises the first ply 202 having the first major surface 106 (outermost surface) and the second major surface 208 (innermost surface), such that the transparency 200 is a single ply (a monolithic transparency). The coating 216 and the uncoated region 218 may be on the second major surface 208 (innermost surface) in the same manner in which the coating 116 and uncoated region 118 from FIG. 1 are shown on the third major surface 110.

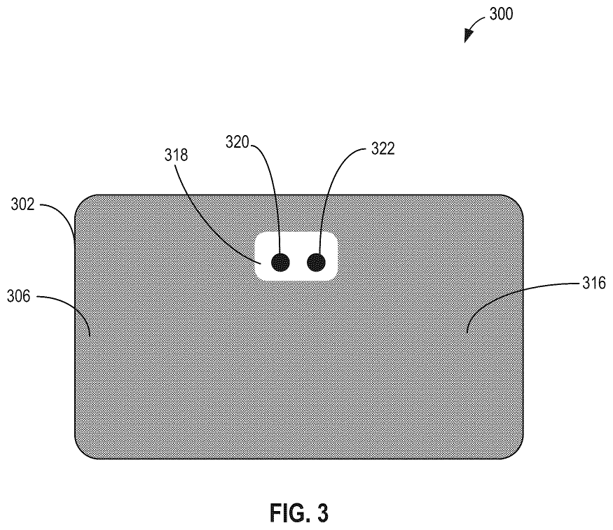

Referring to FIG. 3, the transparency 300 is shown comprising a coated region having the coating 316 and the uncoated region 318, according to some aspects of the disclosure. The transparency 300 in this non-limiting example is a windshield of a vehicle, but may be any other type of transparency. FIG. 3 shows the transparency 300 from the outside of the transparency 300 (closest to the first major surface 306). The coating 316 and the uncoated region 318 are shown, but for clarification, the coating 316 may be applied over the first major surface 306 or additionally or alternatively over a different surface of the transparency 300 (e.g., the third major surface 110 from FIG. 1 or the second major surface 208 from FIG. 2), and the uncoated region 318 similarly refers to an uncoated region of the coated surface. The outermost first major surface 306 may be uncoated and/or coated with a coating that does not substantially interfere with predetermined wavelength(s) of infrared radiation (e.g., 905 nm, 1550 nm, or other pre-selected wavelength), such that the outermost first major surface 306 does not decrease the transmission at the predetermined wavelength(s) by more than 1%, such as 0%. The uncoated region 318 may have the same color and/or spectral properties as previously described in connection with the glass substrate.

While the coating 316 is shown shaded for illustration purposes, it will be appreciated that the coating 316 and the uncoated region 318 may both appear visibly transparent and indistinguishable or nearly indistinguishable to the naked eye, as both may be highly transparent in the visible region, while having different transmission properties in at least one region outside the visible spectrum (e.g., in the infrared region or a portion thereof).

The coating 316 may be a solar control coating in order to control the amount of solar radiation entering the interior of the vehicle, and to prevent the interior of the vehicle from excessive heating. The area of uncoated region 318 not containing the solar control coating may be selected so as to be large enough to not interfere with a radiation source 320 and a radiation detector 322 of the vehicle, while being small enough to minimize the area not protecting the interior of the vehicle from excessive heating.

With continued reference to FIG. 3, the radiation source 320 may be arranged proximate the uncoated region 318 and may be arranged to emit radiation at the predetermined wavelength(s) through the uncoated region 318. The radiation source 320 may be positioned in the interior of the vehicle, such as being mounted on a rearview mirror. The radiation source 320 may emit radiation in a range of 800 nm to 2500 nm through the uncoated region 318. Non-limiting examples of predetermined wavelengths that may be emitted by the radiation source 320 include 905 nm, 1550 nm, or other wavelength determined as a standard wavelength for use in autonomous vehicle navigation.

The radiation detector 322 may be arranged proximate the uncoated region 318 and may be arranged to detect radiation at the predetermined wavelength(s) transmitted through the uncoated region 318. The radiation detector 322 may be positioned in the interior of the vehicle, such as being mounted on a rearview mirror. For example, the radiation detector 322 may detect radiation in a range of 800 nm to 2500 nm transmitted through the uncoated region 318. Non-limiting examples of predetermined wavelengths that may be detected by the radiation detector 322 include 905 nm, 1550 nm, or other wavelength determined as a standard wavelength for use in autonomous vehicle navigation. The radiation detector 322 may detect at least a portion of the radiation emitted by the radiation source 320 that has been reflected off an object and back at the vehicle (e.g., reflected radiation).

As shown in FIG. 3, the radiation source 320 and/or the radiation detector 322 may be at least partially enclosed by the glass substrate of the transparency 300. For example, the radiation source 320 and/or the radiation detector 322 may be arranged inside the vehicle, such as behind the windshield of the vehicle, such that the emitted radiation travels from inside the vehicle, through the transparency 300, to the outside of the vehicle, and the detected radiation travels from outside the vehicle, through the transparency 300, to the inside of the vehicle. In some non-limiting embodiments or aspects, the uncoated region 318 may be arranged on a portion of the transparency 300 proximate to the rearview mirror (not shown) of the vehicle, and the radiation source 320 and/or the radiation detector 322 may be mounted to the rearview mirror. However, other positional arrangements of the uncoated region 318, the radiation source 320, and/or the radiation detector 322 are contemplated within the scope of this disclosure.

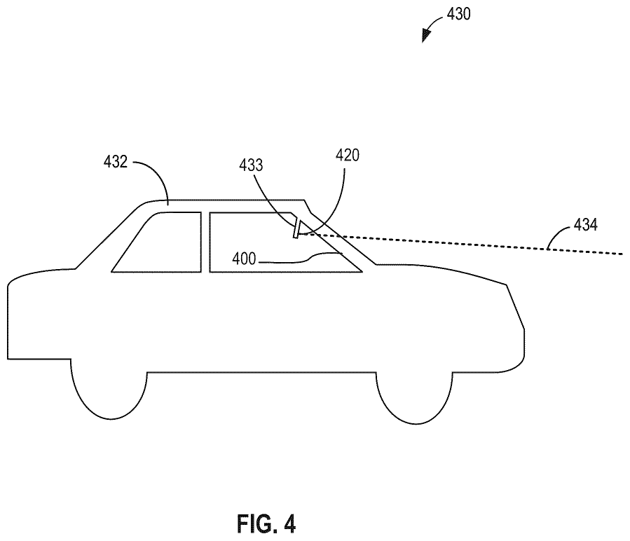

FIG. 4 shows a detection system 430, according to some aspects of the disclosure. The detection system 430 may comprise a first vehicle 432, as an automobile in this non-limiting example. The first vehicle 432 may have the transparency 400 as its windshield, which transparency 400 may be the glass substrate formed from the glass composition of the present disclosure. The first vehicle 432 may comprise a rearview mirror 433, and a region of the transparency 400 may be uncoated (not shown) proximate the rearview mirror 433. The radiation source 420 may be mounted to the rearview mirror 433. The radiation source 420 may emit radiation (emitted radiation 434) at a predetermine wavelength(s) (e.g., in the infrared radiation) through the uncoated region of the transparency 400. The first vehicle 432 may be an autonomous vehicle.

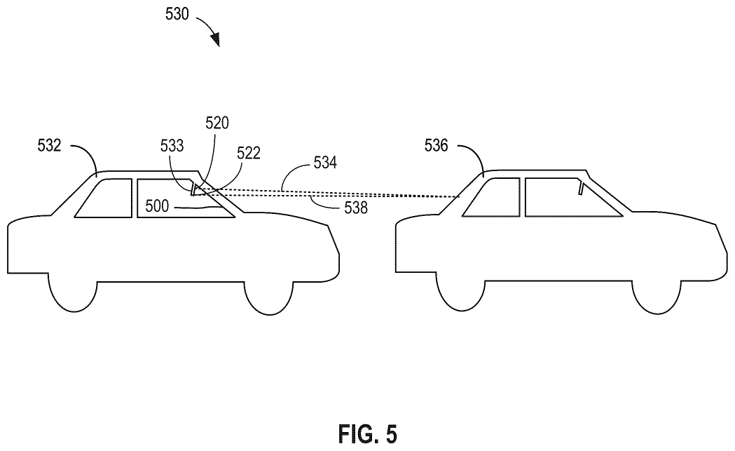

FIG. 5 shows a detection system 530, according to some aspects of the disclosure. The detection system 530 of FIG. 5 is identical to the detection system of FIG. 4 except as described hereinafter. The first vehicle 532 may comprise the radiation detector 522 mounted to the rearview mirror 533, the radiation detector 522 configured to detect predetermined radiation wavelengths (e.g., in the infrared radiation) transmitted through the uncoated region (not shown) of the transparency 500.

The detection system 530 may further comprise a second vehicle 536, as an object detected by the first vehicle 532. The radiation source 520 may emit the emitted radiation 534 through the transparency 500 and directed at the second vehicle 536. At least a portion of the emitted radiation 534 may reflect off of the second vehicle 536 as reflected radiation 538. At least a portion of the reflected radiation 538 may transmit through the transparency 500 of the first vehicle 532 and be detected by the radiation detector 522. Based on the reflected radiation 538 detected by the radiation detector 522, the first vehicle 532 may modify at least one operation of the first vehicle 532 as described herein.

While the emitted radiation 534 in FIG. 5 reflects of the second vehicle 536, it will be appreciate that the second vehicle 536 may instead be any object in the path of the first vehicle 532, such as a pedestrian, other forms of transportation (e.g., bike, scooter, skateboard, etc.), signage, traffic control objects (e.g., barriers, speed bumps, traffic cones, etc.), wildlife, a building or other structure, or any other object obstructing the roadway or path of the first vehicle 532.

While FIGS. 4 and 5 show an arrangement of various components involved in the detection of the reflected radiation (e.g., the first vehicle 432/532, the radiation source 420/520, the radiation detector 522), it will be appreciated that this arrangement of components is non-limiting, such that the components may be arranged relative to one another in a different configuration that allows the first vehicle 432/532 to emit and detect radiation to modify operation of the first vehicle 432/532 as described herein.

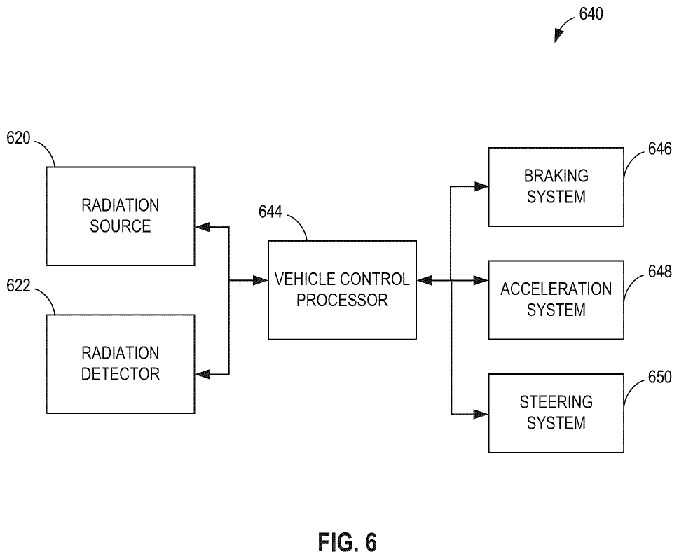

Referring to FIG. 6, a control system 640 is shown, according to some aspects of the disclosure. The control system 640 may be used for operating an autonomous vehicle, such as the first vehicle 432/532 from FIGS. 4 and 5. As used herein, an “autonomous vehicle” may refer to a vehicle capable of sensing its environment and executing at least one function without human intervention based on the sense environment. For example, the autonomous vehicle may execute at least one of the following driving functions without human intervention: steering, braking, accelerating, shifting, and the like. The autonomous vehicle may be “fully” autonomous in that it does not require a human operator for most or all of its driving functions, or the autonomous vehicle may be “semi” autonomous in that it requires a human operator for certain conditions or operations.

The control system 640 may comprise the radiation source 620 and the radiation detector 622 as previously described. The control system 640 may comprise a vehicle control processor (VCP) 644, a braking system 646, an acceleration system 648, and/or a steering system 650. Each of these components may comprise at least one processor. Each of these components may be separate computing components, or certain of these components may be integrated into the same computing component.

The radiation source 620 and/or the radiation detector 622 may be in communication with the VCP 644. The VCP 644 may be in communication with the braking system 646, the acceleration system 648, and/or the steering system 650. As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some non-limiting embodiments or aspects, a message may refer to a network packet (e.g., a data packet and/or the like) that includes data.

With continued reference to FIG. 6, the radiation source 620 mounted on the autonomous vehicle may emit infrared radiation, wherein the emitted radiation is transmitted through a glass substrate on the autonomous vehicle formed from the glass composition. The radiation source 620 may communicate data to the VCP 644 regarding the emitted radiation, such as the timing of the emission of the radiation, the wavelength(s) of the emission, the timing of the cessation of the emission, and the like. FIGS. 4 and 5 show a non-limiting example of the radiation source 620 (420/520 in FIGS. 4 and 5) of a vehicle emitting radiation.

The radiation detector 622 mounted on the autonomous vehicle may detect infrared radiation reflected off an object incident to the emitted radiation. The radiation detected by the radiation detector 622 may comprise at least a portion of the radiation emitted by the radiation source 620 (after said radiation reflects off the object incident to the emitted radiation). The radiation detector 622 may communicate data to the VCP 644 regarding the detected radiation, such as the timing of the detection of the radiation, the wavelength(s) of the detection, the intensity of the detection, the timing of the cessation of the detection, and the like. FIG. 5 shows a non-limiting example of the radiation detector 622 (522 in FIG. 5) detecting reflected radiation.

In response to receiving data from the radiation source 620 and/or the radiation detector 622, the VCP 644 may determine at least one condition of the vehicle's surroundings. The at least one condition may be based on the detected radiation from the radiation detector 622. The at least one condition may include, for example, a speed of travel and/or direction of travel of the autonomous vehicle, a speed of travel and/or direction of travel of the object in the path of the autonomous vehicle, a distance between the autonomous vehicle and the object in the path of the autonomous vehicle, a shape of the object in the path of the autonomous vehicle, whether current operation of the autonomous vehicle will result in a collision or avoid a collision with the object in the path of the autonomous vehicle, weather and/or road conditions, and the like.

Based on the at least one determined condition, the VCP 644 may modify at least one operation of the autonomous vehicle. The VCP 644 may modify the operation of the autonomous vehicle automatically without requiring a user operator intervention. The VCP 644 may modify the operation of the autonomous vehicle to avoid a collision with the object in the path of the autonomous vehicle. The VCP 644 may modify the operation of the autonomous vehicle by sending a control signal to at least one of the braking system 646, the acceleration system 648, and the steering system 650.

For example, the VCP 644 may send a control signal to the braking system 646 to cause the brake of the autonomous vehicle to automatically be applied or released. The control signal may indicate the degree to which the brake should be applied or released, the duration of the application or release of the brake, and the like.

For example, the VCP 644 may send a control signal to the acceleration system 648 to cause the accelerator of the autonomous vehicle to automatically be applied or released. The control signal may indicate the degree to which the accelerator should be applied or released, the duration of the application or release of the accelerator, and the like.

For example, the VCP 644 may send a control signal to the steering system 650 to cause steering of the autonomous vehicle to automatically be adjusted. The control signal may indicate a direction to steer (e.g., left or right), the degree to which the steering should be adjusted, the duration of the adjustment to the steering, and the like.

While the VCP's 644 control of the braking system 646, acceleration system 648, and steering system 650 have been described herein, it will be appreciated that the VCP 644 may send a control signal to other components of the autonomous vehicle to effect control thereof based on the data received from the radiation source 620 and/or the radiation detector 622.

The following numbered clauses are illustrative of various aspects of the disclosure:

Clause 1: A glass composition, comprising: from 65 to 75 weight % SiO₂; from 10 to 20 weight % Na₂O; from 5 to 15 weight % CaO; from 0 to 5 weight % MgO; from 0 to 5 weight % Al₂O₃; from 0 to 5 weight % K₂O; from greater than 0 and up to 0.030 weight % total iron (Fe₂O₃); and from greater than 0 and up to 0.003 weight % FeO.

Clause 2: The glass composition of clause 1, comprising from 0.002 to 0.025 weight % total iron.

Clause 3: The glass composition of clause 1 or 2, wherein the glass composition comprises a sum of colorants less than 1 weight %, wherein the sum of colorants comprise iron-containing, manganese-containing, and chromium-containing compounds.

Clause 4: The glass composition of any of clauses 1-3, comprising a redox ratio (FeO/Fe₂O₃) of up to 0.3.

Clause 5: The glass composition of any of clauses 1-4, comprising from 0.0001 to 0.0075 weight % Cr₂O₃ and/or from 0.0005 to 0.2 weight % MnO₂.

Clause 6: The glass composition of any of clauses 1-5, comprising from 0.0001 to 0.0075 weight % Cr₂O₃ and from 0.0005 to 0.2 weight % MnO₂.

Clause 7: The glass composition of any of clauses 1-6, wherein the glass composition forms a colorless glass.

Clause 8: The glass composition of any of clauses 1-7, wherein the glass composition forms a glass having: an L* value of at least 85; an a* value from −2.5 to +5.0; and a b* value from −1.0 to +5.0.

Clause 9: The glass composition of any of clauses 1-8, wherein a glass substrate formed from the glass composition has a transmission at 905 nm and/or at 1550 nm of at least 91%.

Clause 10: The glass composition of any of clauses 1-9, wherein a glass substrate formed from the glass composition has a T_{Vis} of at least 85% using CIE standard illuminant A.

Clause 11: The glass composition of any of clauses 1-10, wherein a glass substrate formed from the glass composition has a T_{IR} of at least 85%, as determined by ISO 13837.

Clause 12: The glass composition of any of clauses 1-11, wherein a glass substrate formed from the glass composition has a T_{Vis}/T_{IR} of at least 0.9, T_{Vis} determined using CIE standard illuminant A and T_{IR} determined by ISO 13837.

Clause 13: The glass composition of any of clauses 1-12, wherein the glass composition is substantially free of a vanadium-containing compound.

Clause 14: The glass composition of any of clauses 1-13, comprising from 0.15 to 0.40 weight % SO₃.

Clause 15: A glass substrate formed from the glass composition of any of clauses 1-14, wherein at least a portion of the glass substrate is free of a coating layer.

Clause 16: A vehicle comprising a glass substrate formed from the glass composition of any of clauses 1-14.

Clause 17: The vehicle of clause 16, wherein the glass substrate comprises: a first glass panel comprising a No. 1 surface and an opposing No. 2 surface; a second glass panel comprising a No. 4 surface and an opposing No. 3 surface; and an interlayer positioned between the first glass panel and the second glass panel, wherein the interlayer contacts the No. 2 surface and the No. 3 surface.

Clause 18: The vehicle of clause 17, wherein the interlayer comprises polyvinyl butyral (PVB).

Clause 19: The vehicle of any of clauses 16-18, wherein the glass substrate at least partially encloses an infrared radiation source positioned to emit near-infrared radiation in a range of 800 nm to 2500 nm through the glass substrate.

Clause 20: The vehicle of clause 19, further comprising an infrared radiation detector positioned to detect reflected near-infrared radiation in a range of 800 nm to 2500 nm, wherein the reflected near-infrared radiation comprises at least a portion of the near-infrared radiation emitted by the infrared radiation source.

Clause 21: The vehicle of any of clauses 16-20, wherein the glass substrate has a transmission at 905 nm and/or at 1550 nm of at least 91%.

Clause 22: The vehicle of any of clauses 16-21, wherein the glass substrate comprises a windshield.

Clause 23: A method of operating an autonomous vehicle comprising: emitting near-infrared radiation in a range of 800 nm to 2500 nm from an infrared radiation source mounted on the vehicle, wherein the emitted near-infrared radiation is transmitted through a glass substrate on the vehicle formed from the glass composition according to any of clauses 1-14; detecting near-infrared radiation in a range of 800 nm to 2500 nm reflecting off an object with an infrared radiation detector mounted on the vehicle, wherein the reflected near-infrared radiation comprises at least a portion of the near-infrared radiation emitted by the infrared radiation source.

Clause 24: The method of clause 23, wherein the glass substrate has a transmission at 905 nm and/or at 1550 nm of at least 91%.

Clause 25: The method of clause 23 or 24, further comprising: determining, with at least one processor, at least one condition of the vehicle's surroundings based on the detected near-infrared radiation.

Clause 26: The method of clause 25, further comprising: modifying, with at least one processor, at least one operation of the vehicle based on the determined at least one condition.

### EXAMPLES

### Examples 1-27

### Glass Compositions

The glass compositions of Examples 1-27 were prepared to have the composition shown in Tables 5A-5C below. The glass compositions further comprise the soda lime glass composition major components within the ranges provided in Table 1. Tables 5A-5C further report the color and spectral properties of glass substrates formed from the glass compositions. Examples 3-10 are examples of float glass. The remaining examples were prepared in an electric furnace. All glass samples were prepared to a thickness of 3.85 mm.

TABLE 5A

| | Ex | 1 | 2 | 3 | 4 | 5 | 6 | 7 | 8 | 9 | 10 |
|---|---|---|---|---|---|---|---|---|---|---|---|
| Ilum A | T Vis (%) | 91.5 | 91.5 | 91.3 | 91.3 | 91.4 | 91.5 | 91.5 | 91.5 | 91.3 | 91.5 |
| ISO 13837 | T UV (%) | 88.5 | 88.4 | 88.3 | 88.2 | 88.2 | 88.7 | 88.8 | 88.6 | 88.6 | 88.6 |
| | T IR (%) | 91.0 | 91.2 | 90.2 | 90.2 | 90.2 | 90.7 | 90.5 | 90.4 | 90.1 | 90.5 |
| | T Solar (%) | 91.1 | 91.2 | 90.6 | 90.6 | 90.6 | 91.0 | 90.8 | 90.8 | 90.6 | 90.8 |
| ISO 9050 | T Solar (%) | 91.1 | 91.2 | 90.6 | 90.6 | 90.6 | 91.0 | 90.8 | 90.8 | 90.6 | 90.8 |
| Transmittance | 905 nm (%) | 91.1 | 91.2 | 90.2 | 90.1 | 90.1 | 90.9 | 90.7 | 90.6 | 90.4 | 90.7 |
| | 1550 nm (%) | 91.1 | 91.3 | 91.1 | 91.1 | 91.1 | 91.5 | 91.3 | 91.2 | 90.9 | 91.2 |
| Ratio | TVIS/TIR | 1.0 | 1.0 | 1.0 | 1.0 | 1.0 | 1.0 | 1.0 | 1.0 | 1.0 | 1.0 |
| Color | L* | 96.59 | 96.60 | 96.55 | 96.55 | 96.55 | 96.62 | 96.60 | 96.62 | 96.55 | 96.61 |
| (D65, 10deg) | a* | −0.06 | −0.06 | −0.12 | −0.12 | −0.14 | −0.11 | −0.12 | −0.12 | −0.14 | −0.12 |
| | b* | 0.27 | 0.23 | 0.19 | 0.18 | 0.20 | 0.23 | 0.21 | 0.21 | 0.17 | 0.22 |
| XRF Analysis | % Fe₂O₃ | 0.0069 | 0.0071 | 0.0082 | 0.0090 | 0.0089 | 0.0077 | 0.0075 | 0.0083 | 0.0086 | 0.0078 |
| | % FeO | 0.0013 | 0.0010 | 0.0027 | 0.0028 | 0.0028 | 0.0015 | 0.0019 | 0.0019 | 0.0024 | 0.0019 |
| | % SO₃ | 0.348 | 0.353 | 0.203 | 0.206 | 0.202 | 0.165 | 0.186 | 0.178 | 0.162 | 0.183 |
| | % Cr₂O₃ | 0.0000 | 0.0000 | 0.00016 | 0.00017 | 0.00020 | 0.00045 | 0.00060 | 0.00100 | 0.00110 | 0.00130 |
| | % MnO₂ | 0.0013 | 0.0040 | 0.0017 | 0.0015 | 0.0018 | 0.0007 | 0.0009 | 0.0009 | 0.0009 | 0.0007 |
| | % TiO₂ | 0.0070 | 0.0070 | 0.0230 | 0.0230 | 0.0230 | 0.0080 | 0.0080 | 0.0080 | 0.0090 | 0.0080 |
| | Redox | 0.188 | 0.141 | 0.329 | 0.311 | 0.315 | 0.195 | 0.253 | 0.229 | 0.279 | 0.244 |

| | | | | | | | | | | |
|---|---|---|---|---|---|---|---|---|---|---|
| Σ (Fe₂O₃ + MnO₂ + Cr₂O₃) | 0.0082 | 0.0111 | 0.0058 | 0.0055 | 0.0061 | 0.0028 | 0.0035 | 0.0035 | 0.0040 | 0.0032 |

TABLE 5B

| | Ex | 11 | 12 | 13 | 14 | 15 | 16 | 17 | 18 | 19 | 20 |
|---|---|---|---|---|---|---|---|---|---|---|---|
| Ilum A | T Vis (%) | 90.9 | 89.8 | 89.6 | 91.2 | 88.0 | 83.0 | 77.6 | 91.2 | 90.8 | 90.3 |
| ISO 13837 | T UV (%) | 87.7 | 62.8 | 46.7 | 88.1 | 87.3 | 86.5 | 86.0 | 88.1 | 87.8 | 87.7 |
| | T IR (%) | 91.7 | 91.6 | 91.7 | 91.4 | 91.7 | 91.5 | 91.4 | 91.6 | 91.8 | 91.8 |
| | T Solar (%) | 91.0 | 88.8 | 87.6 | 91.0 | 89.7 | 87.4 | 84.9 | 91.0 | 93.0 | 90.7 |
| ISO 9050 | T Solar (%) | 90.9 | 88.8 | 87.5 | 91.0 | 89.7 | 87.3 | 84.8 | 91.0 | 91.0 | 90.7 |
| Transmittance | 905 nm | 91.8 | 91.7 | 91.8 | 91.1 | 91.7 | 91.5 | 91.2 | 91.5 | 91.9 | 91.9 |
| | (%) | | | | | | | | | | |
| | 1550 nm | 92.0 | 91.9 | 92.0 | 91.5 | 92.0 | 92.0 | 91.9 | 91.8 | 92.0 | 92.1 |
| | (%) | | | | | | | | | | |
| Ratio | TVIS/TIR | 1.0 | 1.0 | 1.0 | 1.0 | 1.0 | 0.9 | 0.8 | 1.0 | 1.0 | 1.0 |
| Color | L* | 96.34 | 95.85 | 95.71 | 96.52 | 94.97 | 92.58 | 89.90 | 96.47 | 96.29 | 96.03 |
| (D65, 10deg) | a* | −0.38 | −1.24 | −2.16 | −0.34 | 1.03 | 2.85 | 4.93 | −0.36 | −0.13 | 0.09 |
| | b* | 0.68 | 2.72 | 4.61 | 0.26 | 0.65 | 0.75 | 0.80 | 0.54 | 0.64 | 0.65 |
| XRF Analysis | % Fe₂O₃ | 0.0069 | 0.0072 | 0.0065 | 0.0070 | 0.0065 | 0.0070 | 0.0069 | 0.0069 | 0.0072 | 0.0077 |
| | % FeO | 0.0000 | 0.0001 | 0.0000 | 0.0007 | 0.0000 | 0.0001 | 0.0002 | 0.0003 | 0.0003 | <0.0003 |
| | % SO₃ | 0.348 | 0.343 | 0.360 | 0.348 | 0.371 | 0.365 | 0.328 | 0.354 | 0.362 | 0.355 |
| | % Cr₂O₃ | 0.0023 | 0.0045 | 0.0070 | 0.0010 | 0.0009 | 0.0012 | 0.0010 | 0.0018 | 0.0017 | 0.0017 |
| | % MnO₂ | 0.0009 | 0.0010 | 0.0012 | 0.0009 | 0.0518 | 0.1011 | 0.1527 | 0.0015 | 0.0144 | 0.0270 |
| | % TiO₂ | 0.0070 | 0.0070 | 0.0070 | 0.0070 | 0.0060 | 0.0070 | 0.0070 | 0.0060 | 0.0060 | 0.0070 |
| | Redox | 0.000 | 0.014 | 0.000 | 0.100 | 0.000 | 0.014 | 0.029 | <0.044 | <0.044 | <0.044 |

| | | | | | | | | | | |
|---|---|---|---|---|---|---|---|---|---|---|
| Σ (Fe₂O₃ + MnO₂ + Cr₂O₃) | 0.0101 | 0.0127 | 0.0147 | 0.0089 | 0.0592 | 0.1093 | 0.1606 | 0.0102 | 0.0233 | 0.0364 |

TABLE 5C

| | Ex | 21 | 22 | 23 | 24 | 25 | 26 | 27 |
|---|---|---|---|---|---|---|---|---|
| Ilum A | T Vis (%) | 80.3 | 91.0 | 90.9 | 91.0 | 91.1 | 90.9 | 90.9 |
| ISO 13837 | T UV (%) | 81.9 | 86.9 | 84.9 | 84.7 | 83.8 | 84.1 | 84.7 |
| | T IR (%) | 90.9 | 91.6 | 91.2 | 90.7 | 90.4 | 90.7 | 90.8 |
| | T Solar (%) | 85.4 | 90.9 | 90.6 | 90.4 | 90.3 | 90.3 | 90.4 |
| ISO 9050 | T Solar (%) | 85.4 | 90.9 | 90.6 | 90.4 | 90.3 | 90.3 | 90.4 |
| Transmittance | 905 nm (%) | 90.8 | 91.7 | 91.2 | 90.7 | 90.3 | 90.7 | 90.8 |
| | 1550 nm (%) | 91.4 | 91.8 | 91.3 | 90.7 | 90.3 | 91.4 | 91.4 |
| Ratio | TVIS/TIR | 0.9 | 1.0 | 1.0 | 1.0 | 1.0 | 1.0 | 1.0 |
| Color | L* | 91.23 | 96.38 | 96.34 | 96.41 | 96.45 | 96.35 | 96.37 |
| (D65, 10deg) | a* | 3.30 | −0.28 | −0.37 | −0.41 | −0.39 | −0.42 | −0.41 |
| | b* | 1.92 | 0.70 | 0.78 | 0.66 | 0.58 | 0.73 | 0.65 |
| XRF Analysis | % Fe₂O₃ | 0.0073 | 0.0107 | 0.0151 | 0.0199 | 0.0251 | 0.0204 | 0.0190 |
| | % FeO | 0.0009 | 0.0002 | 0.0009 | 0.0019 | 0.0025 | 0.0019 | 0.0017 |
| | % SO₃ | 0.369 | 0.357 | 0.366 | 0.367 | 0.355 | 0.377 | 0.356 |
| | % Cr₂O₃ | 0.0017 | 0.0019 | 0.0019 | 0.0020 | 0.0014 | 0.0021 | 0.0021 |
| | % MnO₂ | 0.0396 | 0.0204 | 0.0201 | 0.0203 | 0.0202 | 0.0202 | 0.0203 |
| | % TiO₂ | 0.0060 | 0.0070 | 0.0060 | 0.0070 | 0.0070 | 0.0100 | 0.0590 |
| | Redox | 0.123 | 0.019 | 0.060 | 0.096 | 0.100 | 0.093 | 0.089 |

| | | | | | | | |
|---|---|---|---|---|---|---|---|
| Σ (Fe₂O₃ + MnO₂ + Cr₂O₃) | 0.0486 | 0.0330 | 0.0371 | 0.0422 | 0.0467 | 0.0427 | 0.0414 |

The glass substrates formed from the low iron, low redox glass compositions of Examples 1-27 exhibit good color and spectral properties and are suitable for use in glass substrates through which high infrared transmittance is desired, such as in autonomous vehicles having infrared sources and/or detectors.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. A glass composition, comprising:
from 65 to 75 weight % SiO₂;
from 10 to 20 weight % Na₂O;
from 5 to 15 weight % CaO;
from 0 to 5 weight % MgO;
from 0 to 5 weight % Al₂O₃;
from 0 to 5 weight % K₂O;
from greater than 0 and up to 0.030 weight % total iron (Fe₂O₃); and
from greater than 0 and up to 0.003 weight % FeO.

2. The glass composition of claim 1, comprising from 0.002 to 0.025 weight % total iron.

3. The glass composition of claim 1, wherein the glass composition comprises a sum of colorants less than 1 weight %, wherein the sum of colorants comprise iron-containing, manganese-containing, and chromium-containing compounds.

4. The glass composition of claim 1, comprising a redox ratio (FeO/Fe₂O₃) of up to 0.35.

5. The glass composition of claim 1, comprising from 0.0001 to 0.0075 weight % Cr₂O₃ and/or from 0.0005 to 0.2 weight % MnO₂.

6. The glass composition of claim 1, comprising from 0.0001 to 0.0075 weight % Cr₂O₃ and from 0.0005 to 0.2 weight % MnO₂.

7. The glass composition of claim 1, wherein the glass composition forms a colorless glass.

8. The glass composition of claim 1, wherein the glass composition forms a glass having:
an L* value of at least 85;
an a* value from −2.5 to +5.0; and
a b* value from −1.0 to +5.0.

9. The glass composition of claim 1, wherein a glass substrate formed from the glass composition has a transmission at 905 nm and/or at 1550 nm of at least 91%.

10. The glass composition of claim 1, wherein a glass substrate formed from the glass composition has a T_{Vis} of at least 85% using CIE standard illuminant A.

11. The glass composition of claim 1, wherein a glass substrate formed from the glass composition has a T_{IR} of at least 85%, as determined by ISO 13837.

12. The glass composition of claim 1, wherein a glass substrate formed from the glass composition has a T_{Vis}/T_{IR} of at least 0.9, Tᵥᵢₛ determined using CIE standard illuminant A and T_{IR} determined by ISO 13837.

13. The glass composition of claim 1, wherein the glass composition is substantially free of a vanadium-containing compound.

14. The glass composition of claim 1, comprising from 0.15 to 0.40 weight % SO₃.

15. A glass substrate formed from the glass composition of claim 1, wherein at least a portion of the glass substrate is free of a coating layer.

16. A vehicle comprising a glass substrate formed from the glass composition of claim 1.

17. The vehicle of claim 16, wherein the glass substrate comprises:
a first glass panel comprising a No. 1 surface and an opposing No. 2 surface;
a second glass panel comprising a No. 4 surface and an opposing No. 3 surface; and
an interlayer positioned between the first glass panel and the second glass panel, wherein the interlayer contacts the No. 2 surface and the No. 3 surface.

18. A method of operating an autonomous vehicle comprising:
emitting near-infrared radiation in a range of 800 nm to 2500 nm from an infrared radiation source mounted on the vehicle, wherein the emitted near-infrared radiation is transmitted through a glass substrate on the vehicle formed from the glass composition according to claim 1;
detecting near-infrared radiation in a range of 800 nm to 2500 nm reflecting off an object with an infrared radiation detector mounted on the vehicle,
wherein the reflected near-infrared radiation comprises at least a portion of the near-infrared radiation emitted by the infrared radiation source.

19. The method of claim 18, further comprising:
determining, with at least one processor, at least one condition of the vehicle's surroundings based on the detected near-infrared radiation.

20. The method of claim 19, further comprising:
modifying, with at least one processor, at least one operation of the vehicle based on the determined at least one condition.
